(19) United States
(12) Patent Application Publication
(10) Pub. No.: US 2009/0030542 A1
(43) Pub. Date: Jan. 29, 2009

(54) Apparatus and method for handling short run quick changeover fabrication jobs

(75) Inventors: Mikko Lindstrom, Geneva, IL (US); Mikael Haag, Desenzano del Garda (IT); Juha Makitalo, Pinsio (FI)

Correspondence Address: LOUIS WOO;LAW OFFICE OF LOUIS WOO, 717 NORTH FAYETTE STREET, ALEXANDRIA, VA, 22314, US

(73) Assignee: Finn-Power International., Inc.

(21) Appl. No.: 11/918,649

(22) PCT Filed: Apr. 11, 2006
(86) PCT No.: PCT/US2006/013458

§ 371 Date: Oct. 17, 2007

Related U.S. Application Data
(60) Provisional application No. 60/672,509, filed on Apr. 19, 2005.

(51) Int. Cl. G05B 19/418; G06F 19/00

(52) U.S. Cl. 700/113; 700/112; 700/213; 700/228

(57) ABSTRACT

In a flexible manufacturing system (FMS), a shelving module of a work cell is fitted with a dedicated lift conveying mechanism so that work materials of desired sizes may be retrieved individually from different shelves of the shelving module for conveyance to the machine of the work cell. By having its own dedicated lift conveying mechanism that operates independently from the transport system that transports raw materials to the wok cells of the FMS, the operation of each cell becomes unaffected by the transport system. As such, materials may be fed to the machine in each cell for fabrication, piece by piece if so desired, by the lift conveying mechanism while the various shelves of the shelving module continue to be stocked by the transport system. Any remnants that prior to the instant invention would have been wasted may be returned to the appropriate shelves of the shelving module for future use by the lift conveying mechanism.

### FIELD OF INVENTION

The present invention relates to sheet fabrication systems and more particularly to a sheet fabrication system capable of short run quick changeover production runs.

### BACKGROUND OF INVENTION

When a particular work or work order is programmed to be done with a work cell in an automated sheet fabrication system such as the Flexible Manufacturing System (FMS) by Finn-Power International, the assignee of the instant invention, material is delivered by a transport mechanism such as the FMS Crane to an I/O station for the work cell. Typically the material is delivered in stacks comprising anywhere from few sheets of parts or blanks to the maximum load handling capacity of the FMS system.

If the cell is, for example, a Finn-Power Punch Shear (Shear Genius) or a machine having similar process capability, the programming of the parts is done by optimizing the material utilization in an effort to eliminate waste. Such programming typically generates multiple nest layouts from the parts that are determined to be produced in a group which can be nested together. One view of such nesting process is given in U.S. Pat. No. 6,788,995, assigned to the assignee of the instant invention. The disclosure of the '995 patent is incorporated by reference herein

As a group of parts is consumed by the machine under the programming software, there may not enough parts for fabrication to fill a sheet at the end. In a worst case scenario, only a single part is fabricated from the last sheet, and the rest of the sheet is therefore wasted. At times up to 90% of the last sheet of a production group is wasted. When many groups are nested daily such waste will add significant cost to the operation.

In today's FMS technology where the material sheet stacks are placed on cassettes, the usage of optional material sheet sizes in nesting optimization is not allowed. This is because that would require more cassette changes and accordingly lead to longer machining times. Usage of optional sheet sizes in nesting optimization can however significantly improve the material usage rate and correspondingly reduce manufacturing costs.

Also, the system changeover time from one material to another material in an I/O station may take several minutes. In a short run production, this long changeover time effectively prohibits the running of consecutive short runs with an FMS system, as most of the time would be wasted due to the material changeover instead being used for production.

To improve this situation some manufacturers have implemented a separate material storage system to feed to a work cell one sheet at the time. Such separate material storage has limitations on how many different sheet sizes and types it can store at any given time. It further requires separate inventory handling and material replenishment routing to fill the inventory for that particular cell.

At times single part production is required from an FMS system. Such process is handled with great difficulty, as the remnant material either is wasted or has to be stored individually, in most instances outside the FMS system. This in turn generates an inventory problem as well as a costly handling problem. Prior to the instant invention, FMS systems are directed more to long production runs that use the same material, and are not meant to be used effectively for single part production runs.

### SUMMARY OF INVENTION

Instead of implementing a separate CS storage system to feed single sheets from outside of the FMS material management system to a manufacturing or work cell otherwise connected to the FMS system, the present invention implements a conveying mechanism such as a lift movable in at least two directions relative to a FMS shelving block adjacent to the cell. The shelving block is made of adjacent stacks or modules each having a plurality of shelves or cassettes, and is located at the I/O station for the particular manufacturing cell. The lift is movably mounted to the side of the shelving block facing the machine of the cell so as to be movable vertically along each of the stacks and horizontally from stack to stack so that it can gain access to each of the shelves or cassettes of the shelving block.

By a program request the lift can retrieve a sheet (or worksheet) of the requested material from a cassette and place the retrieved sheet onto a platform of a feeder conveyor system so that the sheet may be moved to a squaring position, or a wait area or station. One such shelving block or module can handle a greater number of shelves than the separate storage system described above in the Background of Invention section. The lift can pick up a sheet from any one of the shelves, or cassettes, in the best and most optimal sequence according to the software instructions. Per the software instructions, the material management system of the FMS will look ahead at the material requirements from its nesting programming system database and will instruct a raw material transport system such as for example the Finn-Power Crane to stock or exchange the material cassettes on the shelving block where the I/O station for the particular cell is.

With the lift conveying mechanism, it is feasible to feed single sheets one at the time to the cell. The next sheet can be different from the one being worked in the cell. Further, subsequent sheets can be queued to wait in the squaring station (or a wait station) so as to be loaded immediately to the cell when the processing of the previous sheet is completed, thus eliminating any delays and waiting times. In the case that a full sheet is not used up, the remnant can be returned to the material storage for later use, thereby preventing such remnant from becoming wasted material.

The possibility of running single sheets, including remnants, without any delay gives the nesting software a great degree of freedom in that the best suitable raw material sheet sizes could be selected at the appropriate time for fabrication, thereby avoiding any negative impact on manufacturing times.

To return the unused material, the feeder system may be arranged as a dual height (over and under) or dual paths conveyor system whereby one level (or path) is utilized for material flow for returning remnants to shelving block and the other level (or path) is utilized for material flow to the manufacturing cell. A road like conveyor system in which one lane, or path, is reserved for loading sheets and the other for returning remnants may also be used.

With the instant invention FMS system, there is real time material management. Also, the inventory control software database is automatically updated with information including any remnants. Accordingly, manual inventory tracking of saved remnant material is eliminated. Further, the remnants are immediately available for use as the system is programmed, per the nesting program, to automatically prioritize the remnants to be used first in the up coming production where the remnants could be used. Being able to utilize remnants effectively is a substantial change from systems available today. As the cost of materials has continuously risen over time, substantial cost savings is generated by the instant invention.

With the number of material cassette locations available in the shelving block, the inventive system can easily maintain material flow in and out, or to and from, the shelving block from the transport side of the shelving block by utilizing the already existing transport system such as for example the FMS crane or the Train from the Finn-Power Night Train, while the lift convey mechanism simultaneously feeds materials and returns remnants from the cell side of the shelving block. With this flexibility and the possibility of using the entire FMS shelving space for material and remnant storage, there is virtually no limit on how much material or the types or sizes of raw materials that can be handled with the instant system.

### DRAWINGS

The present invention will best be understood with reference to the figures as described hereinbelow, in which:

FIG. 1 is an overall plan view of the inventive system;

FIGS. 2a to 2c are respective rear, side and front views of an exemplar shelving module of the instant invention equipped with a lift conveying mechanism;

FIGS. 3a-3d are a plan view, a front view, a perspective view and a partial side view, respectively, of the inventive lift conveying mechanism;

FIG. 4 is an exposed view of a grasping device such as a suction cup that is a part of the inventive lift conveying mechanism;

FIG. 5 is an exposed view of the motor and transmission system of the inventive lift conveying mechanism;

FIG. 6 is a perspective view of a number of shelving modules of a shelving block relative to a material transport and the lift conveying mechanism;

FIG. 7 is a side view of a shelving module and the conveying mechanism working cooperatively therewith;

FIG. 8 is an overall view of a large FMS system showing a plurality of work cells; and

FIG. 9 is an enlarged view of a portion of the FMS system shown in FIG. 8.

### DESCRIPTION OF INVENTION

### Terms and Functions

FMS System—A sheet fabrication system such as the Finn-Power Night Train system or the like. A FMS system comprises at least one raw material/work in process material shelving block or module with fixed or removable shelving and means to move/transport material from one shelf location to another shelf location, or to a station that can move the material to another predetermined or freely adjustable position for further handling of the material.

Cassette—A shelf that is removable, typically rectangular platform (having a size for example 5′ by 10′) to store raw material and work in process material. It is used also in various sorting systems to receive work in process material for transporting the material to a shelf location and/or to another work station.

Cell—Machinery interfaced to the FMS system to receive raw or work in process material to be processed in the cell. The material is moved by means of a transport device such as the FMS Crane, or the Finn-Power Train in the Finn-Power Night Train system. More advanced cells can also make stacks of the parts processed in the cells. Such stacks can be placed onto a cassette for the FMS Crane to retrieve and move to subsequent processing at another cell or the work in process material storage location for the FMS system.

I/O station, MO, MOW, MOWL—Various different interfacing stations that can receive raw or work in process material delivered by FMS Crane, Finn-Power Train or the like. Different stations have different capabilities to interface with a cell, where the loading or unloading system used in a particular cell will determine which kind of interfacing station is needed. The herein discussed interfacing stations can also be used to send the material into the FMS system for further processing in another cell or for storing the work in process material for the FMS system.

Squaring station—This device performs alignment operations to square the material or parts, either individually or in stacks, to meet the alignment/squaring criteria for the next fabrication step or process. For the understanding of the instant invention, the squaring station may also be referred to as a wait area or a wait station.

Nest Layout—A process for effecting optimal placement of parts on a sheet blank to minimize waste. Nest layout is generated by programming system by optimizing which parts make the best fit when placed together onto a determined sheet size. See incorporated by reference '995 patent. Programming can be made with systems such as Finn-Power NC Express or Finn-Power Manufacturing Suite software system.

Shelving Module and Lift Storage system—A rectangular shaped raw material storage shelving module has two long sides and two short sides. The shelving module has a fixed number of shelves, typically 5-12 in one unit. A lift or lifter mechanism is movably mounted to one side of the module. It is adaptable to retrieve material from and return material to the different shelves of the module by means of a grasping or lift mechanism such as a vacuum cup lift device. The sheets removed from the shelves are conveyed or placed, one at a time if required, onto the squaring table. With such system, material may be retrieved from any of the storage locations one sheet at the time and delivered to a squaring station in short cycle time. In reverse, a remnant sheet can be returned to any one of the shelf locations.

### DISCUSSION OF EMBODIMENT

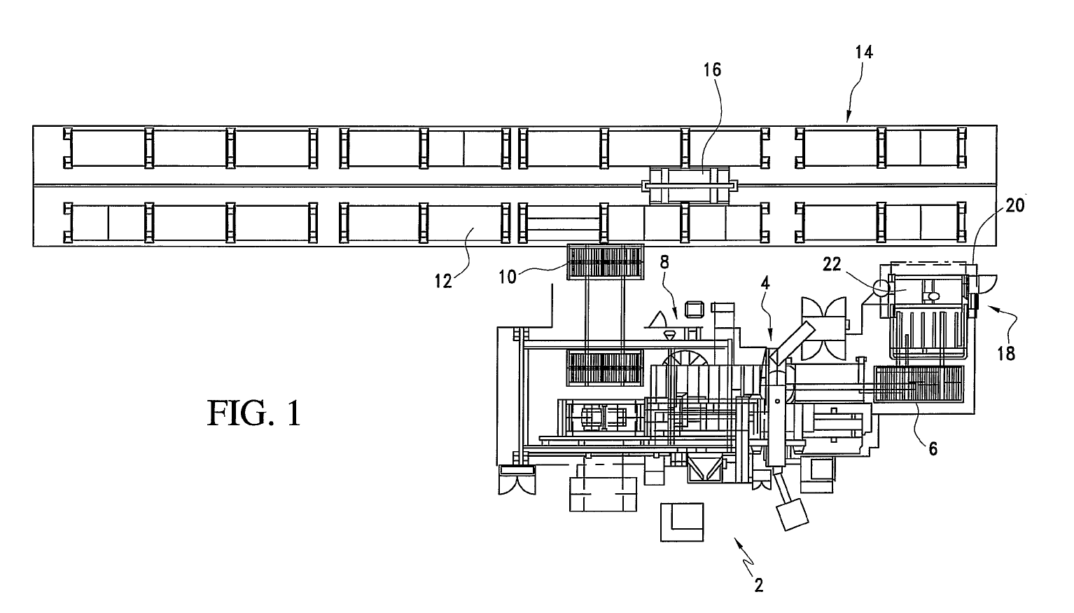

FIG. 1 shows a FMS system, and more particularly a manufacturing or work cell 2 that includes at least one machine such as for example a turret punch press 4 and devices for handling worksheets or raw materials to be fabricated by turret punch press 4. A loader or conveyor 6 would bring the workpeices to machine 4 while an unloader 8 would unload the finished products to an unload conveyor 10 that unloads the finished products to pallets or cassettes 12 of a material transport system 14. A transport device such as the Finn-Power Train or Crane 16 retrieves the finished product and transports it to another work cell for further processing, or for shipping.

The instant invention FMS system implements, at the interface station 18 positioned relative to the transport system 14 and work cell 2, a conveying mechanism 20 to a shelving module 22. For the exemplary embodiment of FIG. 1, interface station 18 is shown interposed between transport system 14 and work sell 2.

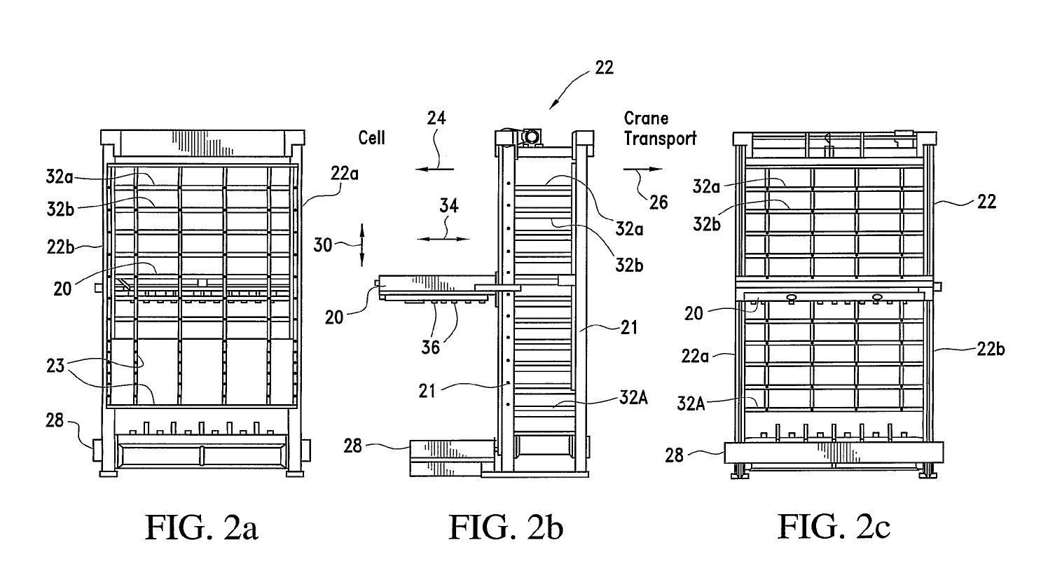

Conveying mechanism 20 is shown to include a lift device in FIGS. 2a-2c. There, lift 20 is shown to be movably mounted to the side of a block or shelving module 22 that faces work cell 2, as indicated by directional arrow 24. The other side of shelving module 22 faces the material transport system 14, which may be a Finn-Power Train or Crane for the FMS system of the assignee. This side of shelving module 22 is designated by arrow 26 and is best shown in FIG. 2a. A protective grid 23 is removable from module 22 when raw materials or to be fabricated worksheets (and work in progress materials) are to be deposited onto the shelves or cassettes of module 22 by transport system 14. Mounted at the base of shelving module 22 at the side of cell 26 is an unloading/loading platform 28 onto which processed products or materials picked up by lift 20 are placed, so that the work materials may further be transported or moved to work cell 2.

Platform 28 is connected by a conveyor to the cell, or more precisely to a square forming or waiting station whereto each worksheet retrieved by the lift is moved and stored in queue, so that the worksheets may be fabricated in sequence by the machine(s) of the cell. The remnant worksheets that have not been fully utilized by the machine and therefore could be used for future fabrication are conveyed back to the platform of the storage module of the interface station by the conveyor.

To allow for the simultaneous movement of the raw worksheets and the remnant worksheets, the conveyor may be configured to have two levels, one level (for example the upper level) for the conveyance of the worksheets to the machine and another level (for example the lower level) for the conveyance of the remnant worksheets from the machine back to the storage module. Alternatively, the conveyor may be divided into two paths, with one of the paths for the conveyance of the worksheets from the storage module to the machine and the other path for the conveyance of the remnant worksheets form the machine back to the storage module.

Lift 20 is mounted to the two vertical rails or guides 22a and 22b of shelving module 22, and is movable vertically up and down shelving module 22 as indicated by directional arrow 30. Shelving module 22 has a number of shelves 32a, 32b to 32n, also known as cassettes, respectively mounted at desirable spatial relationship to upright supports 21. It is onto the cassettes that raw materials (or work in progress worksheets) or remnants of materials that have been used are placed. Each of the cassettes of shelving module 22 may contain materials or worksheets of different sizes. Further, each of the cassettes may be exchanged for a replacement cassette, for example by transport system 14 removing an empty cassette and replacing it with a replacement cassette that is stocked with anywhere from a few sheets to the maximum stack of worksheets of a given size or dimension.

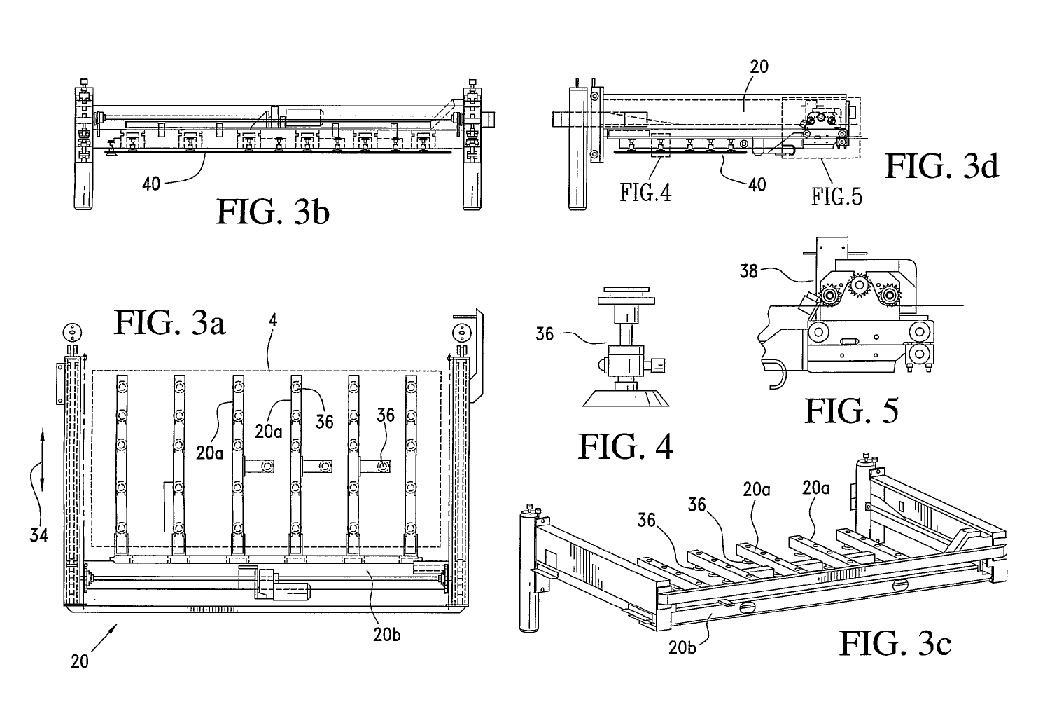

To retrieve a worksheet of a particular size, or to return a remnant from the processing of a worksheet to the cassettes, lift 20 is adaptable to move into and out of the cassettes or shelves in the direction as designated by directional arrow 34. To grasp the workpiece, be it raw or work in progress material for processing or remnant to be returned for future processing needs, lift 20 has a number of grasping devices such as for example the suction cups 36 shown in FIG. 4. Suction cups 36 are mounted to the underside of lift 20, as best shown in FIG. 3d. To provide movement for lift 20, a motor and transmission system 38, as shown in FIG. 5, is used. Since such motor and transmission system is well known, no further explanation is deemed necessary, other than suffice it to say that motor and transmission system 38 drives lift 20 bidirectionally in both the vertical and horizontal directions, as indicated by directional arrows 30 and 34 shown in FIG. 2b.

As more clearly shown in FIGS. 3a to 3d, lift 20 includes a number of crossbars 20a. These crossbars are mounted to a support 22b. Mounted underneath each of the crossbars 20a are a number of suction cups 36 for grasping a worksheet 40, best shown in FIG. 3b and in dotted line in FIG. 3a. As support 20b is movable bidirectionally as indicated by directional arrows 34, crossbars 20a-n of lift 20 could be inserted into shelving module 20 and more specifically to the appropriate shelf or cassette 32 so as to retrieve a worksheet of a desired size to be fabricated by the machine at work cell 2, or to place in the appropriate cassette a remnant material that could be used for future processing. Thus, with lift 20, it is possible to feed sheets of required dimensions one at a time to the work cell, with the singly fed sheets being queued in a wait station or area (or the square forming station) to await operation by the machine.

The queuing of worksheets in the wait station is independent of, and if desired could be timed to exceed, the operational speed of the machine(s) in the cell, with the wait station acting as a buffered storage area for the machine. Consequently, as there is a steady supply of correctly dimensioned worksheets queued up in the wait area, or the square forming station, waiting to be worked on in sequence by the machine, and as the sheets to be fabricated by the machine are continually being stored in the wait station as contrast to if the worksheets were individually fed to the machine for each operation, the delays and wait times that otherwise would result from the machine having to wait for the next worksheet to arrive for fabrication are eliminated. This is especially true in the case where the machine has been programmed to do different production runs, each of which may require worksheets of different dimensions. For the instant invention, with predetermined worksheets of given sizes being continually stored in a queue (in accordance with the production run program requirements) ahead of the next production run or at least a step ahead of the next sheet required for the current production run, there is no need for the machine to stop its operation for the different production runs. In other words, the machine is able to quickly changeover from one production run to another, and from another to yet another, etc, so long as the worksheets being queued in the waiting station continually match what the machine requires for each of the programmed production runs.

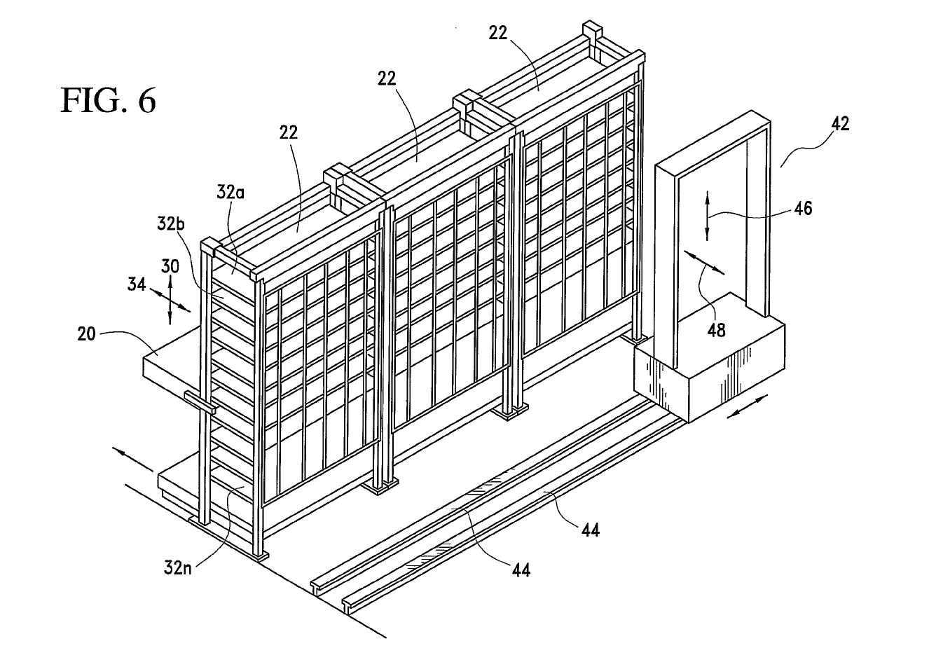

FIG. 6 is a perspective view that shows the interrelationship between a number of shelving modules 22, a material transport device 42 that transports raw materials to the various cassettes of the shelving modules 22 and the lift conveying mechanism 20, which is adapted to retrieve one piece at a time the material that is to be worked on by the machine of the work cell. As was described above, lift conveying mechanism 20 is also adaptable to return any remnants of worksheets not fully used by the machine to the appropriate cassettes of the shelving modules.

As shown in particular by the exemplary embodiment of FIG. 6, there are three shelving modules 22 stacked adjacent to each other. Although three shelving modules are shown, it should be appreciated that there may be more or less shelving modules. For the work cell of the instant invention, only one shelving module with a plurality of cassettes is required.

The transport device 42 shown in FIG. 6 may be a Finn-Power Train from the Finn-Power Night Train system or a Finn-Power Crane from the Finn-Power FMS system. Other types of transport that is capable of transporting materials from a main storage to the shelving modules of the FMS system could also be used. For the exemplar embodiment shown, assume that the transport device 42 comprises a vehicle or cart having a crane mounted thereto or embedded therein. The cart or vehicle moves along tracks 44 and is movable among the various shelving modules of the multiple work cells of the FMS system and the external storage system that stores the raw materials to be worked on by the various cells of the FMS system.

Transport device 42 is capable of moving materials both vertically and horizontally, as indicated by directional arrows 46 and 48, respectively. Thus, the raw materials being carried by transport device 42 could be selectively stocked onto the different cassettes or shelves 32 of the plurality of shelving modules 22.

In addition to stocking materials in the shelves or cassettes, transport crane 42 can also exchange the different cassettes on the storage module, so that a replacement cassette that may already be stocked with raw materials could be substituted for an empty cassette, or one that is substantially used up or that has raw materials that may not be needed for the production runs. The ability to simply substitute one cassette by another speeds up the restocking process. Transport device 42 has a crane arm or material mover that is adapted to exchange the cassettes and also to move materials (worksheets) stocked or stored on the transport selectively to the different shelves or cassettes of the shelving modules 22. So, too, the crane arm of transport device 42 can selectively remove materials from particular ones of the shelves of the different shelving modules 22 to reduce the materials stocked in the modules.

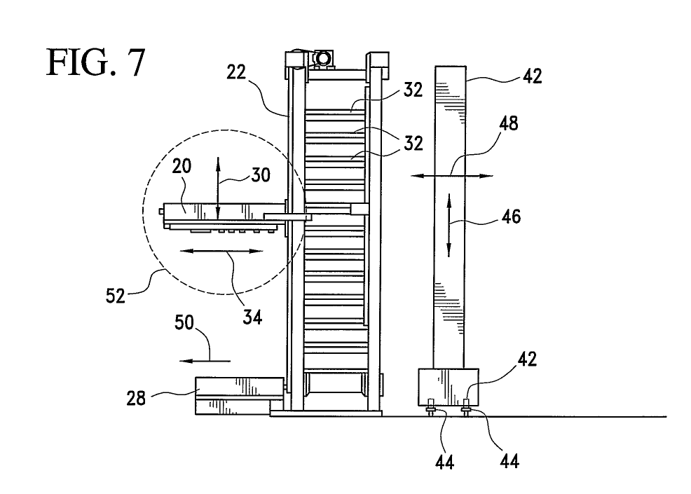

On the other side of shelving module 22, as best shown in FIG. 7, lift 20 is movably mounted to shelving module 22 so as to be moveable therealong in the vertical direction, so that lift 20 can vertically gain access to any one of the cassettes 32 of shelving module 22. As lift 20 is also adaptable to move in the horizontal direction as indicated by directional arrow 34, the suction cups 36 mounted to the underside of lift 20 are movable along the horizontal direction into and out of the different shelves or cassettes 32 of shelving module 22. Once lift 20 has retrieved the appropriate raw material for processing by the machine of the work cell, it lowers itself to place the material onto loading/unloading platform 28. After lift 20 has moved away from the cassette, the workpiece may be conveyed from platform 28 to the machine for processing, per directional arrow 50. The conveying of worksheets from platform 28 to the machine may be done by a conventional conveyor system or by the use of a robotic arm (or other movable devices) that may be added to the FMS system.

For the instant invention, lift 20 as identified by dotted circle 52 may be considered a conveying mechanism that is adapted to transfer worksheets or raw materials from respective cassettes 32 of the shelving module 22 to the machine, or conversely remnant worksheets from the machine to selective ones of the cassettes 32. Lift 20 may be programmed to selectively retrieve individual worksheets from corresponding shelves and/or selectively place remnants of worksheets singly onto corresponding shelves. This is made possible because lift 20 is dedicated to the particular manufacturing or work cell whereas, as was discussed in the Background of the Invention section, the conventional transport system relies on a transport that traverses between a separate material storage system and the work cell in order to be able to feed materials one piece at a time to the work cell. The programming of a lift device to pick up worksheets one piece at a time is conventional and therefore will not be further elaborated.

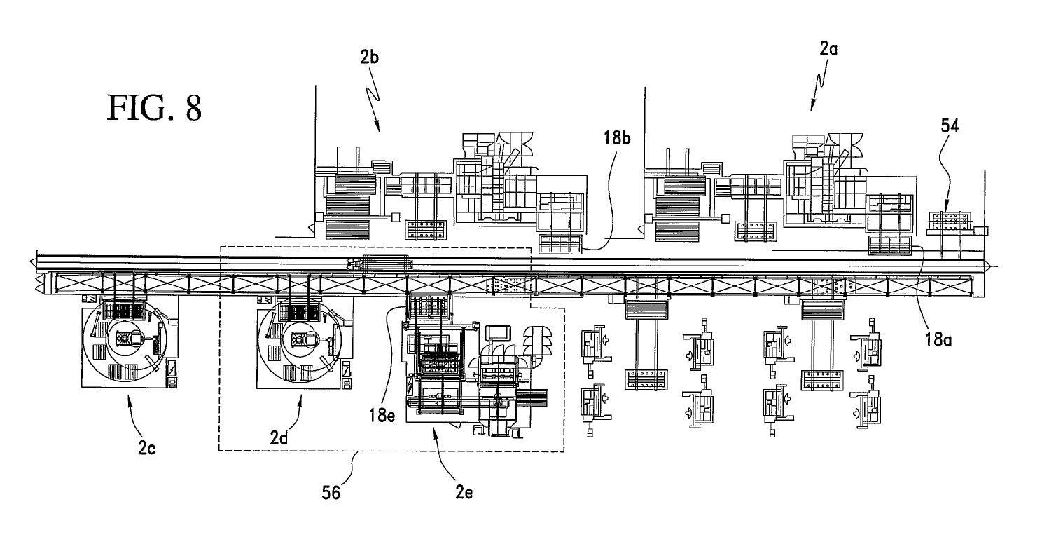

FIG. 8 shows an FMS system that includes a number of work cells identified as 2a, 2b, 2c, 2d and 2e. An input/output (I/O) station for this FMS system is designated 54. For each of cells 2a, 2b and 2e, there is a corresponding combination shelving module and lift conveying mechanism that is the same as the portion of the FMS system identified as 18 in FIG. 1 and shown in greater detail in FIGS. 2a-2c. As shown, cell 2a may contain a turret punch press, cell b may contain a combination laser and punch press, cells 2c and 2d each may contain a bending machine, and cell 2e may contain a laser cutter.

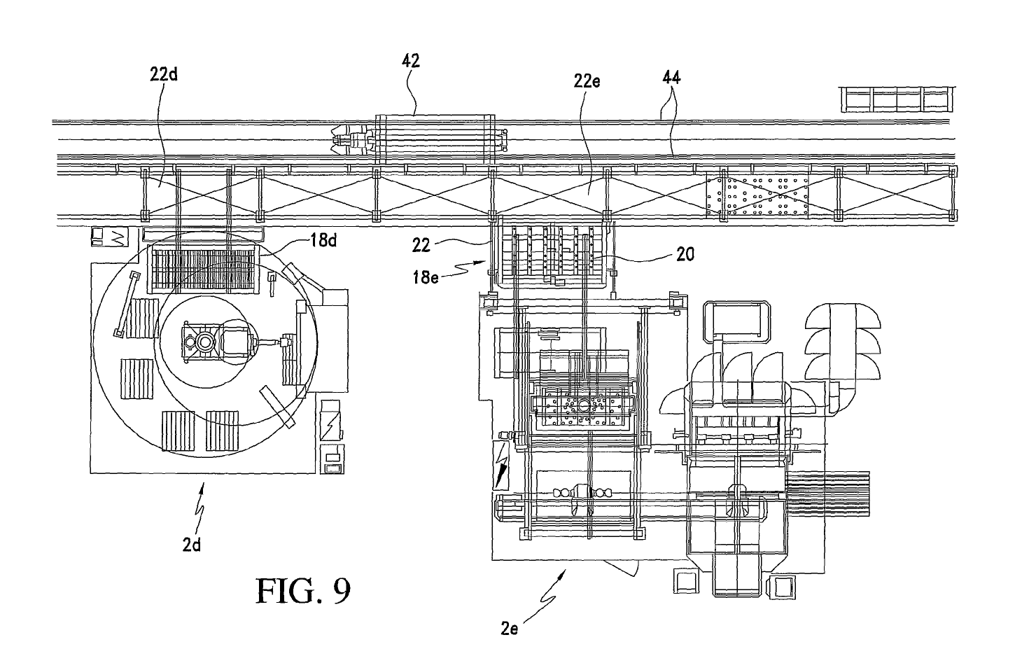

The portion of the FMS system shown in FIG. 8 and identified in dotted box 56 is amplified in FIG. 9. There a transport device 42, such as for example the Finn-Power Train or a transport vehicle, would carry raw materials to the various shelving modules 22 that are lined up along the transport tracks 44. For the system shown, even though transport 42 is physically away from shelving modules 22e and 22d of the cells 2e and 2d, respectively, each of work cells 2e and 2d nonetheless can continue to operate. Putting it differently, cell 2e can operate in a single piecemeal fashion, due to its dedicated lift 20 that is movable relative to the shelving module 22 for retrieving materials of varying sizes in a piecemeal fashion for fabrication by the machine(s) of cell 2e. Cell 2d likewise may also be separately operational inasmuch as it has its own interface station 18d where raw materials or worksheets are provided to and finished worksheets are removed from cell 2d independent of the fact that transport 42 is not at the moment stocking its cassettes with raw materials. For the exemplar embodiment shown in FIG. 8, to more efficiently restock the shelving modules 22 of the different work cells, material transport 42 may dock with a particular shelving module, when needed, and replaces the empty cassettes with pre-stocked replacement cassettes.

By having a buffer in the form of an interface station that allows a machine in a work cell to continue to operate even when the work cell is not being re-supplied with raw materials from an external material transport, and by further providing a queue of materials of different dimensions that may be used for different production runs, the machine may readily be programmed to changeover from one production run to another without having to stopped. This would have been quite difficult, if not impossible, prior to the instant invention, as the machine is required to stop its operation after every production run so that sufficient amount of the raw materials required for the next production run could be supplied to the machine.

1. A system comprising: a cell including at least one machine adaptable to fabricate worksheets of different sizes, an interface station for receiving worksheets, a material transport for delivering the worksheets to the interface station, a conveying mechanism for transferring the worksheets from said interface station to said machine, wherein said interface station includes a plurality of stores each adapted to store worksheets of a given dimension, and wherein worksheets of different dimensions are transferable by said conveying mechanism to said machine for fabrication, said conveying mechanism adapted to transfer one sheet at a time from selective ones of said stores to said machine for fabrication.

2. System of claim 1, wherein said interface station comprises at least one shelving module containing a plurality of said stores, said stores being shelves or cassettes each for storing given worksheets; and wherein said conveying mechanism comprises a lift device that is movable in at least two directions for selective movements to the different shelves or cassettes to retrieve one worksheet at a time from said shelves or cassettes.

3. System of claim 1, wherein said conveying mechanism moves each of the worksheets selectively retrieved from said interface station to a wait station or area at said cell in a queue to be worked on sequentially by said machine.

4. System of claim 1, wherein said interface station comprises a platform whereon worksheets selectively retrieved from respective ones of said shelves or cassettes of said module are placed; and
wherein said conveying mechanism comprises a conveyor device for moving each of the retrieved worksheets from said platform to a wait station or area in a queue to be worked on by said machine.

5. System of claim 1, wherein said material transport comprises a transport vehicle movable among a plurality of interface stations of a plurality of cells, a material mover of said transport vehicle adapted to selectively move materials into and out of the different stores of the interface station.

6. System of claim 2, wherein said material transport is adapted to selectively replace a cassette at said interface station with a replacement cassette.

7. System of claim 1, wherein said conveying mechanism comprises a conveyor having a first path for conveying the worksheets from said interface station to said machine for fabrication and a second path for conveying remnants of worksheets not fully used by said machine back to said interface station.

8. System of claim 1, further comprising: a wait area whereto worksheets from said interface station singly conveyed by said conveying mechanism are placed in queue for fabrication by said machine, the worksheets being placed in the wait station or area independent of the operational speed of said machine.

9. In combination, a cell having at least one sheet fabrication machine, a material transport, at least one storage module positioned relative to said machine and said material transport, said storage module having a plurality of cassettes each adapted to store worksheets of a given dimension, a conveying mechanism working cooperatively with said storage module for conveying worksheets one at a time between said storage module and said machine, a wait station whereto worksheets to be fabricated by said machine are stored in queue as the worksheets are conveyed from said storage module so that said machine can work on the worksheets in accordance to the order that the worksheets are to be worked on, the supply of worksheets to said wait station being such that the operation of said machine is not interrupted due to a lack of worksheets.

10. Combination of claim 9, wherein said conveying mechanism is adapted to also convey remnants of worksheets not fully used by said machine back to said storage module.

11. Combination of claim 9, wherein said material transport is adapted to stock the plurality of cassettes with worksheets of different dimensions, said material transport is further adapted to selectively replace a cassette in said storage module with a replacement cassette.

12. Combination of claim 9, wherein said conveying mechanism comprises a lift device movable relative to the plurality of cassettes of said storage module for selectively retrieving one worksheet at a time from said cassettes.

13. Combination of claim 12, wherein said conveying mechanism further comprises a conveyor for conveying the worksheets retrieved by said lift device to said wait station.

14. Combination of claim 13, wherein said conveyor comprises a first path for conveying worksheets from said storage module to said wait station and a second path for conveying remnants of worksheets not fully used by said machine back to said storage module.

15. An interface station, comprising:
a storage module having a plurality of cassettes each adapted to store at least one worksheet of a given dimension;
a conveying mechanism movably coupled to said storage module, said conveying mechanism including a lift movable relative to said shelves, said conveying mechanism further including a material pick up device adapted to be selectively moved into any one of said cassettes to pick up a worksheet from said any one cassette; and
a platform positioned relative to said conveying mechanism where onto worksheets picked up by said pick up device are deposited;
wherein said interface station is positioned relative to a transport mechanism that is adapted to transport worksheets to or from said interface station and at least one sheet fabrication machine whereto worksheets deposited on said platform are conveyed one at a time to said machine for fabrication.

16. Interface station of claim 15, wherein said platform is further adapted to receive remnants of fabricated worksheets, each worksheet remnant deposited on said platform is picked up by said pick up device and deposit thereby to an appropriate cassette of said storage module so that the worksheet remnant may further be used for future fabrication.

17. Interface station of claim 15, wherein said platform is coupled to a conveyor adapted to convey a worksheet on said platform to said machine and convey a worksheet remnant from said machine to said platform.

18. In a manufacturing system having a sheet fabrication machine and a material transport for transporting worksheets to said machine, a method of reducing delays in the operation of the sheet fabrication machine, comprising the steps of:
a) positioning an interface station having at least one storage module including a plurality of cassettes relative to said machine and said material transport;
b) stocking worksheets of different dimensions transported by said material transport to corresponding different cassettes of said interface station;
c) retrieving worksheets singly from the different cassettes of said interface station in accordance to the desired order of the worksheets to be fabricated;
d) conveying the singly retrieved worksheets to a waiting station for storage in queue in accordance to the sequence in which the worksheets are to be fabricated by said machine; and
e) ensuring a continuous supply of worksheets be stored in queue in said wait station so that the operation of said machine is not interrupted due to a lack of worksheets.

19. Method of claim 18, further comprising the steps of:
conveying remnants of worksheets not fully used by said machine back to said interface station; and
restocking the remnants to the appropriate cassette for later use.

20. Method of claim 18, wherein said step b further comprises the step of:
selectively replacing cassettes in said storage module with other cassettes.
